(19) United States
(12) Patent Application Publication
(10) Pub. No.: US 2018/0232598 A1
(43) Pub. Date: Aug. 16, 2018

(54) RECURSIVE OBJECT ORIENTED PATTERN MATCHING

(71) Applicant: Microsoft Technology Licensing, LLC, Redmond, WA (US)

(72) Inventor: Daniel Isaiah Vann, Duvall, WA (US)

(73) Assignee: Microsoft Technology Licensing, LLC, Redmond, WA (US)

(21) Appl. No.: 15/429,777

(22) Filed: Feb. 10, 2017

(51) Int. Cl. G06K 9/62; G06K 9/34

(52) U.S. Cl. CPC G06K 9/6202; G06K 2009/6213; G06K 9/342; G06K 9/6261

(57) ABSTRACT

Examples of the present disclosure describe systems and methods for recursive object oriented pattern matching. A pattern object may be a simple or a complex pattern. A simple pattern may be used to identify an exact match, and inexact match, or a range or set match. A complex pattern may comprise one or more sub-patterns (e.g., simple or complex patterns) and a match of the complex pattern may be conditioned on the match results for the one or more sub-patterns. In some examples, a pattern may have one or more properties associated with it, wherein a property further refines the characteristics of a potential match for the pattern. Validation criteria may be used to evaluate potential matches while parsing input data. The pattern and sub-patterns of the pattern may be evaluated recursively and structured hierarchically thereby providing greater performance, readability, extensibility, and reusability.

### BACKGROUND

Pattern matching techniques may be used to parse input data. For example, patterns may be used to identify matches within the input data. However, as a pattern becomes more complicated, formulating or expressing the pattern using traditional linear representations may yield representations that are difficult to read, revise, and reuse. Further, the evaluation of such complex patterns using traditional methods may be resource-intensive and may therefore result in decreased performance.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for recursive object oriented pattern matching. A pattern may be comprised of a simple pattern or a complex pattern. A simple pattern may consist of logic used to identify an exact match, an inexact match, or a match comprised of a range or set of values. A complex pattern may comprise one or more simple or complex sub-patterns. A complex pattern may comprise logic that may be used to evaluate an input based on the match results of one or more of its sub-patterns. In some examples, a pattern may have one or more properties associated with it, wherein a property further refines the characteristics of a potential match for the pattern (e.g., whether capitalization is evaluated, what type of delimiters are expected, etc.). In other examples, validation criteria may be evaluated when a potential match is identified, thereby enabling match validation to be performed while parsing input data rather than after parsing has completed.

Sub-patterns of a pattern may be evaluated recursively. As an example, sub-patterns of a complex pattern may be evaluated, and the results may then be used to generate a match result for the complex pattern. In an example, the hierarchical structure of the pattern and/or one or more sub-patterns may be stored or represented as an object in order to provide greater readability, extensibility, and reusability than was previously possible with traditional pattern representations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an example system for evaluating input data using recursive object oriented pattern matching.

FIG. 2 illustrates an example object oriented pattern that may be evaluated recursively according to aspects disclosed herein.

FIG. 3 illustrates an example method for evaluating input data using recursive object oriented pattern matching.

FIG. 4 illustrates an example method for evaluating an input using an object oriented pattern.

FIG. 5 is a block diagram illustrating example physical components of a computing device with which aspects of the disclosure may be practiced.

FIGS. 6A and 6B are simplified block diagrams of a mobile computing device with which aspects of the present disclosure may be practiced.

FIG. 7 is a simplified block diagram of a distributed computing system in which aspects of the present disclosure may be practiced.

FIG. 8 illustrates a tablet computing device for executing one or more aspects of the present disclosure.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

The present disclosure generally relates to recursive object oriented pattern matching. A variety of input data may be evaluated using pattern matching techniques, including, but not limited to, textual data, binary data (e.g., image data, video data, audio data, etc.), a data stream, or any combination thereof. A pattern may comprise any number of criteria used to match input data, including simple patterns such as exact or literal matches, fuzzy (e.g., inexact, wildcard, etc.) matches, or range or set matches (e.g., matching a range or a set of characters or other data), among other criteria. In some examples, a pattern may comprise a complex pattern further comprised of one or more sub-patterns, wherein the complex pattern describes a match modifying or relating to the one or more sub-patterns. As will be appreciated, the instant disclosure may refer to a “pattern” or “sub-pattern” interchangeably, such that aspects discussed herein relating to a “pattern” may also apply to a “sub-pattern,” and vice versa.

As an example, a complex pattern may comprise multiple sub-patterns (e.g., simple or complex patterns), such that a match of any one of the sub-patterns constitutes a match of the complex pattern. In another example, a complex pattern may specify that, after identifying a match for a sub-pattern, additional occurrences of the same sub-pattern match should be identified within the input data. Complex patterns may specify other logic or criteria, including, but not limited to, a sequential match of a group of sub-patterns, a list match of a group of sub-patterns (e.g., a match for each sub-pattern, where each match may be separated by a delimiter, such as a comma, a whitespace character, or one or more of any combination of other characters), or where a sub-pattern may be matched a certain number of times. As will be appreciated, a complex pattern may specify other conditions relating to one or more sub-patterns in order to specify logic for parsing data input. Further, it will be appreciated that a complex pattern may modify one or more simple sub-patterns, one or more complex sub-patterns, or a combination thereof.

A pattern or sub-pattern may be associated with one or more properties to further refine what matches are identified when parsing input data. For example, a property may indicate whether a pattern is case-sensitive, what types of delimiter characters are matched, values to exclude from potential matches, an occurrence frequency for potential matches, among other indications. In an example, a property may store metadata information, including, but not limited to, a pattern name, a last modified or last accessed date, what type of data may be processed using the pattern, or what type of information the pattern is designed to recognize (e.g., a date, an email address, a list, a segment of computer code, a sentence relating to a certain topic, etc.). Table 1 illustrates a nonexclusive list of example properties.

TABLE 1
Example Properties of a Pattern or Sub-Pattern

| Property Name | Description |
|---|---|
| AllowDecimals | Specifies if decimals may be allowed |
| AllowIntegers | Specifies if integers may be allowed |
| AllowNegatives | Specifies if negatives may be allowed |
| AllowPositives | Specifies if positives may be allowed |
| CaptureEnclosingCharacters | Specifies whether the enclosing characters may be included in captures |
| CaseSensitivity | Indicates whether a pattern may be case sensitive |
| CaseTypes | Specifies what types of cases may be accepted by a pattern |
| CharacterRanges | The set of character ranges that may be included in a pattern |
| Characters | Indicates the individual characters that may be included in a pattern |
| Delimiter | Specifies which characters are used to separate nested patterns |
| End | Characters that may denote the end of the enclosed text |
| ExcludedCharacterRanges | The set of character ranges that may be excluded from a pattern |
| ExcludedCharacters | Individual characters that may be excluded from a pattern |
| Exclusion | A pattern for values that may be excluded |
| IsExhaustive | Whether a pattern may be exhaustive and may return matches of all lengths |
| IsRequired | Specifies if a pattern may be required |
| Literal | The literal contained in a pattern |
| Literals | The literals represented by a pattern |
| MaxCharacters | The maximum number of characters that may be included in a pattern |
| MaxDigits | The maximum number of digits that may occur in a pattern |
| MaxLetters | The maximum number of letters that may occur in this pattern |
| MaxOccurrences | The maximum number of times a sub-pattern may occur |
| MaxOccurrences | The maximum number of nested patterns that may occur |
| MaxPrecision | The maximum number of digits that may occur after a decimal point |
| MaxSpecialCharacters | The maximum number of special characters that may occur in a pattern |
| MinCharacters | The minimum number of characters that may be included in a pattern |
| MinDigits | The minimum number of digits that may occur in a pattern |
| MinLetters | The minimum number of letters that may occur in a pattern |
| MinOccurrences | The minimum number of times a sub-pattern may occur |
| MinOccurrences | The minimum number of nested patterns that may occur |
| MinPrecision | The minimum number of digits that may occur after a decimal point |
| MinSpecialCharacters | The minimum number of special characters that may occur in a pattern |
| Name | Name of a pattern, matches may be accessed or referenced based on this name |
| NestedPatterns | Set of nested pattern that may be contained in a pattern |
| Pattern | A pattern defined by a custom pattern |
| PatternType | Specifies the type of a pattern |
| SpaceAfter | Specifies if a pattern may be followed by a space |
| SpaceBefore | Specifies if a pattern may be preceded by a space |
| SpecialCharacters | Special characters to include in a pattern |
| Start | Characters that may denote the start of the enclosed text |
| SubPattern | Indicates sub-pattern that may occur multiple times |
| WhiteSpaceTypes | The types of white space characters that may be included in a pattern |

In another example, validation criteria may be associated with a pattern, such that matches that are identified when evaluating the pattern may be validated against the validation criteria. In some examples, validation criteria may be stored as a property. Validation criteria may specify a wide array of possible conditions, including, but not limited to, range or value validation, data comparison (e.g., between other matches, with another data source, etc.), or syntax validation. As an example, validation criteria may specify that, if a date is matched, the date must be after a certain date, before a certain date, within a year of a certain date, etc. Validation criteria may also be used to validate matches in relation to other matches. For example, matches for a pattern used to identify email addresses may be validated to determine whether subsequent matched email addresses relate to the same domain as previous matches. External information may also be used when validating a match, including, but not limited to, remotely-stored information (e.g., from a website, data store, remote application or service, or other remote system), locally-stored information (e.g. from a local storage device, a local application or service, etc.), or any other source of data or information. While specific validation criteria examples are described above, any criteria may be used to validate potential matches identified by a pattern as described herein.

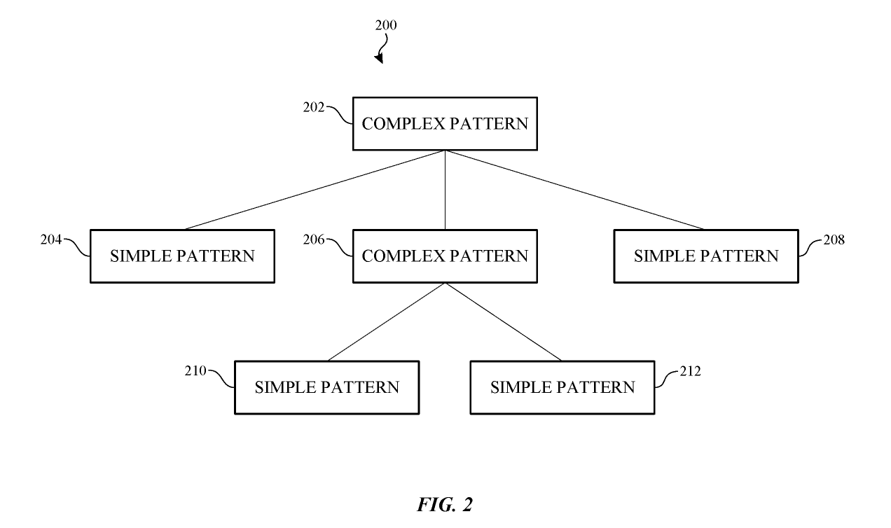

A pattern may be represented or stored as an object, a variable, or other data structures. The object may capture the hierarchical nature of the pattern (e.g., where the pattern is comprised of one or more sub-patterns, each or some of which may be further comprised by additional sub-patterns, etc.). Further, an object may store additional information, including properties or information relating to previous matches or previous input data characteristics, among other data. As an example, a pattern object may comprise a complex sub-pattern, which itself may further comprise one or more sub-pattern objects. This will be discussed in greater detail with respect to FIG. 2.

As compared to a traditional pattern representation (e.g., where a pattern may represented using a complicated sequence of characters conforming to a specific syntax), an object oriented approach may provide greater readability, extensibility, and reusability, due to the inherent structure and modularity provided by formulating a pattern as a hierarchy of pattern objects. Even so, it will be appreciated that an object oriented pattern may be represented or stored in a variety of formats, including as a sequence of characters or any other linear or textual representation. In an example, the object oriented nature of a pattern as disclosed herein may be used to create a new pattern type by extending a pre-existing pattern type (e.g., a simple or complex pattern, or another previously-created pattern). The new pattern type may comprise new or different matching logic, sub-patterns, properties, or validation criteria. When a pattern comprises the new pattern type, it may be used to parse input data according to aspects disclosed herein. An update to the new pattern type (e.g., modifying matching logic, sub-patterns, properties, or validation criteria) may cause future parsing using the pattern (which, in an example, may remain unchanged) to be performed according to the updated new pattern type comprised within the pattern.

The pattern may be evaluated recursively, meaning that each pattern or sub-pattern of the pattern may be evaluated in turn rather than enumerating a universe of possible matches and evaluating an input by sequentially iterating through the enumerated matches. As an example, for a complex pattern further comprising two simple sub-patterns, the complex pattern may be evaluated to determine that it comprises two sub-patterns. Each sub-pattern may be used to evaluate at least a subpart of the input data, and the results of each evaluation may then be provided to the complex pattern for additional processing. The additional processing may determine whether the complex pattern has been satisfied based on the results returned from the sub-patterns, after which match information for the complex pattern may be provided. As discussed above, each of the pattern and sub-patterns may be associated with properties that further refine potential match conditions or indicate one or more validation criteria. As a result of evaluating a pattern recursively, such properties may be evaluated when matches are identified by a pattern or sub-pattern, rather than after parsing has been performed as was previously the case with tradition pattern matching techniques.

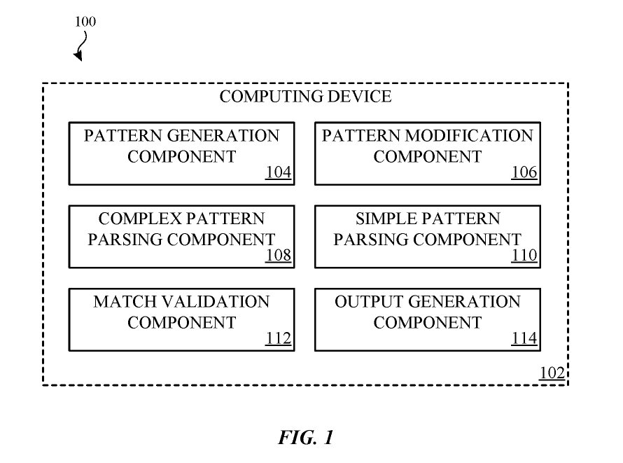

FIG. 1 illustrates an example system 100 for evaluating input data using recursive object oriented pattern matching. Example system 100 comprises computing device 102, which is comprised of pattern generation component 104, pattern modification component 106, complex pattern parsing component 108, simple pattern parsing component 110, match validation component 112, and output generation component 114. Computing device 102 may be a personal computing device, tablet computing device, mobile computing device, or distributed computing device, among others. In another example, computing device 102 may be a distributed computing device, such that multiple computing devices may be used to perform the functions of components 104-114. Additionally, components 104-114 may be hardware components, software components, or any combination thereof.

Pattern generation component 104 may be used to generate a pattern for evaluating input data. In an example, pattern generation component 104 may generate a simple pattern or a complex pattern comprising one or more sub-patterns (e.g., as received from a user, as specified in a program or application, as stored in a data store, or from any other source). The generated pattern may also have one or more properties or validation criteria relating to the pattern or to one or more sub-patterns. Given the hierarchical nature of simple and complex nested patterns and sub-patterns, a property may modify a single pattern within the pattern (e.g., a simple or complex pattern and no other related patterns) or may modify a pattern and one or more of its sub-patterns (e.g., a complex pattern and at least one of the sub-patterns on which it depends).

In another example, pattern generation component 104 may retrieve additional information when generating a pattern, including, but not limited to, results from a database query, the contents of a file (e.g., a word list, a manifest, etc.), or information retrieved from a locally or remotely executing application or process. Pattern generation component 104 may use this information when generating a pattern or sub-pattern, such that at least a part of the additional information is part of the pattern or sub-pattern and is used when evaluating input data using the generated pattern (e.g., using complex pattern parsing component 108, simple pattern parsing component 110, or match validation component 112). In some examples, pattern generation component 104 may store or represent the generated pattern as an object in accordance with aspects described herein.

Pattern modification component 106 may be used to modify a pre-existing pattern. In an example, the pre-existing pattern may have been created by pattern generation component 104. In some examples, at least a subpart of the pre-existing pattern may be copied into a new pattern object, such that the copy of the pre-existing pattern is modified rather than the pre-existing pattern itself. Modifying a pattern may comprise altering a pattern or sub-pattern (e.g., changing the type of pattern, the match criteria of the pattern, which sub-patterns are related to the pattern, etc.), adding a sub-pattern, removing a sub-pattern, or any combination thereof. As discussed above, a pattern may be modified (rather than creating a new pattern) in order to reuse a pattern for a similar but different purpose (e.g., matching an email address having a different domain, matching a sentence having a similar structure but relating to a different topic or having a different verb tense, etc.).

Complex pattern parsing component 108 may be used to evaluate one or more complex patterns and/or sub-patterns. As discussed above, a complex pattern may be comprised of one or more sub-patterns(e.g., simple or complex patterns), wherein the complex pattern describes criteria relating to the one or more sub-patterns. As such, complex pattern parsing component 108 may identify one or more sub-patterns of a complex pattern and process each sub-pattern accordingly. As an example, if a sub-pattern is a complex pattern, complex pattern parsing component 108 would process the complex sub-pattern. By contrast, if the sub-pattern is a simple pattern, complex pattern parsing component 108 would provide the simple sub-pattern to simple pattern parsing component 110 for processing. Complex pattern parsing component 108 may receive match results from simple pattern parsing component 110. The results of processing each sub-pattern may then be used to further evaluate the complex pattern.

As an example, complex pattern parsing component 108 may determine whether any of the sub-patterns contained in the complex pattern were satisfied and, if at least one was, determine that the complex pattern was matched. In another example, complex pattern parsing component 108 may use match validation component 112 to evaluate one or more validation criteria when determining whether a complex pattern was satisfied. Evaluating the validation criteria may comprise analyzing one or more sub-pattern match results, the result of the complex pattern itself, or a combination thereof. As will be appreciated, complex pattern parsing component 108 may evaluate match results for one or more sub-patterns of the complex pattern using any type of logic or criteria without departing from the spirit of this disclosure. In some examples, complex pattern parsing component 108 may provide match results (e.g., the match result of evaluating the complex pattern, the match results of evaluating the one or more sub-patterns, or a combination thereof) to output generation component 114 or, in the case where the complex pattern is a sub-pattern of another complex pattern, to complex pattern parsing component 108.

Simple pattern parsing component 110 may be used to evaluate one or more simple patterns. As discussed above, a simple pattern may specify logic or criteria that may be used to parse input data in order to identify one or more exact or literal matches, fuzzy or inexact matches, or range or set matches, among other matches. Parsing the input data may comprise analyzing one or more subparts of the input data to determine whether a subpart comprises information that matches the simple pattern. In some examples, the subpart may be evaluated using the simple pattern in view of one or more associated properties, such as whether the simple pattern is case-sensitive, whether line-breaks or other whitespace should be ignored, etc. In other examples, a subpart identified to match the simple pattern may be validated using one or more validation criteria by match validation component 112. Simple pattern parsing component 110 may provide the results of parsing input data using the simple pattern to output generation component 114 or, in the case where the simple pattern is a sub-pattern of a complex pattern, to complex pattern parsing component 108.

Match validation component 112 may validate a potential match of a simple or complex pattern (e.g., as identified by complex pattern parsing component 108 and/or simple pattern parsing component 110) in order to determine whether the potential match satisfies one or more validation criteria. As such, match validation component 112 may perform additional processing of the potential match before the potential match is determined to be a match for the simple or complex pattern. In an example, match validation component 112 may compare the potential match to previously identified matches, validate the content or syntax of the match, or use external information to validate the match, among other processing. An indication may be provided by match validation component 112 (e.g., to complex pattern parsing component 108 or simple pattern parsing component 110) that indicates whether the potential match was validated. In an example, match validation component 112 may enable match validation of potential matches identified in input data during the parsing process (e.g., while the input data is being parsed by complex pattern parsing component 108 and/or simple pattern parsing component 110), rather than after parsing has been completed as previously the case using traditional pattern matching techniques.

Output generation component 114 may generate one or more outputs based on the match results returned by parsing a pattern (e.g., using complex pattern parsing component 108, simple pattern parsing component 110, and/or match validation component 112). In an example, output generation component 114 may provide the matches that were identified as a result of parsing the pattern. In some examples, the provided matches may include partial matches (e.g., where a subset of the patterns or sub-patterns were satisfied, or where a subpart of a pattern was matched, etc.). A confidence score or match percentage may be provided, wherein the value indicates the degree to which an identified match matches the pattern. In other examples, output generation component 114 may perform additional processing using the identified matches, including, but not limited to, generating an output using a template resource (e.g., selecting a template and/or populating one or more fields of a template based on identified matches), summarizing or categorizing the identified matches, or generating a response or other output based on the identified matches.

In one example, the input data may be received from a client as part of a conversation, dialogue, or other interaction. The input data may be parsed according to aspects disclosed herein to generate match results. At least a part of the match results may be provided (e.g., by output generation component 114) to an artificial intelligence entity, language processing entity, or other computing entity. The entity may then perform processing using the received match results in order to generate a response, which may then be provided to the client.

As an example, a pattern may be used to parse the input data “I don't want to play piano today, but I would like to play basketball tomorrow.” The pattern may comprise a complex pattern specifying a sequential group of sub-patterns, such that each of the sub-patterns must be matched in order. The first sub-pattern may be a literal match simple pattern specifying a literal match for the word “play.” The next sub-pattern may be an option match complex sub-pattern comprising a series of simple sub-patterns, such that a match of any of the simple sub-patterns constitutes a match of the complex sub-pattern. The option match complex sub-pattern may be comprised of multiple literal match simple sub-patterns, each of which indicates a literal match for a type of sport: “football,” “basketball,” and “baseball”. The final sub-pattern may also be an option match complex sub-pattern relating to time, comprising literal match simple sub-patterns for “yesterday,” “today,” and “tomorrow.”

When parsing the input data, complex pattern parsing component 108 may determine that the pattern is a complex pattern as described above, and identify the three sub-patterns. As the first sub-pattern is a simple pattern, complex pattern parsing component 108 may provide the sub-pattern and at least a part of the input data to simple pattern parsing component 110 for further processing. Simple pattern parsing component 110 may identify a literal match of the word “play” as the fifth word of the input data. In some examples, simple pattern parsing component 110 may proceed to parse the remainder of the input data, identifying another match at the thirteenth word of the input data. In other examples, simple pattern parsing component 110 may provide this match result to complex pattern parsing component 108.

Complex pattern parsing component 108 may receive the literal match from simple pattern parsing component 110, and proceed to evaluate the next sub-pattern (e.g., the sports option match complex sub-pattern). Complex pattern parsing component 108 may evaluate the complex sub-pattern, and determine that it is comprised of multiple simple sub-patterns. As such, each of the constituent simple sub-patterns may be evaluated by simple pattern parsing component 110 in order to determine whether there is a match. Given that the text after “play” in the input data is not one of “football,” “basketball,” or “baseball,” but is rather “piano,” none of the simple sub-patterns will be matched. Complex pattern parsing component 108 may receive such an indication from simple pattern parsing component 110, and may determine that, since none of the simple sub-patterns of the complex sub-pattern were matched, the complex sub-pattern was not matched. In some examples, this instance of parsing the input may terminate and the evaluation may progress to the next occurrence of the first sub-pattern (e.g., the thirteenth word of the input data, matching the literal match simple sub-pattern for “play”). In other examples, parsing may continue in order to determine whether a partial match is possible. If parsing continues, it may be determined that the final sub-pattern is matched, because the text proceeding “piano” satisfies one of the simple sub-patterns comprised in the final option match complex sub-pattern (e.g., the literal match simple sub-pattern for “today”). As a result, a partial match result may be identified for the example pattern by complex pattern parsing component 108.

Parsing may then progress to the next occurrence, where complex pattern parsing component 108 may again provide the first sub-pattern (e.g., the literal match simple sub-pattern) to simple pattern parsing component 110. Here, similar to as was discussed above, “play” may be matched, but as the thirteenth word of the input data. This match result may be provided to complex pattern parsing component 108, which may then progress to evaluating the next sub-pattern: the option match complex sub-pattern for sport types. As described above, each of the constituent simple sub-patterns may be evaluated by simple pattern parsing component 110, and it may be determined that there is a literal match for the “basketball” simple sub-pattern. As a result, complex pattern parsing component 108 may receive this result and determine that, since at least one of the constituent simple sub-patterns was matched, the second sub-pattern (e.g., the complex sub-pattern for sport types) is matched. Finally, the third sub-pattern (e.g., the option match complex sub-pattern relating to time) may also be evaluated, such that each of the constituent simple sub-patterns are provided to simple pattern parsing component 110 for processing. Simple pattern parsing component 110 may identify a literal match for the “tomorrow” simple sub-pattern. Complex pattern parsing component 108 may receive this match result and determine that the third sub-pattern is matched.

As a result of determining that all three sub-patterns of the complex pattern specifying a sequential group of sub-patterns has been matched, complex pattern parsing component 108 may determine that a full match, comprising the text “play basketball tomorrow,” has been identified. “Play” as a result of matching the first sub-pattern, “basketball” as a result of matching the second sub-pattern, and “tomorrow” as a result of matching the third sub-pattern. In some examples, the match results may be provided to output generation component 114 for further processing.

In an example, the complex pattern discussed above for matching a type of sport may be defined as a new pattern type: a sport pattern. The sport pattern may extend the complex pattern type, and may comprise a predefined list of sports (e.g., one or more simple sub-patterns, each of which may match a specific of sport type). In another example, the sport pattern may have additional properties that were not previously provided by a complex pattern. For example, sports-specific criteria such as whether a sport is played with a ball, if the sport is an Olympic sport, etc. The sport pattern may be used to generate or define patterns just as simple or complex patterns may be used to do so according to aspects disclosed herein. The sport pattern may be updated to include additional sport types (e.g., “hockey”), specify additional or alternative logic or criteria, or modify one or more properties, among other updates. As a result of an update, input data that is parsed using a pattern comprising a sport pattern object may be parsed according to the updated sport pattern type. As will be appreciated, while pattern type extensibility is described above in relation to a sports pattern, a pattern may be extended to relate to, identify, or process any type of input data, subject domain, or criteria.

FIG. 2 illustrates an example object oriented pattern 200 that may be created and evaluated according to aspects disclosed herein. Object oriented pattern 200 may have been created by pattern generation component 104 in FIG. 1. Object oriented pattern 200 is comprised of a hierarchy of pattern objects, where complex pattern 202 is comprised by simple pattern 204, complex pattern 206, and simple pattern 208. Similarly, complex pattern 206 is itself comprised by simple pattern 210 and simple pattern 212. As illustrated, complex pattern 202 has three sub-patterns: simple pattern 204, complex pattern 206, and simple pattern 208. Similarly, simple patterns 210 and 212 may be sub-patterns of complex pattern 206. As disclosed herein, object oriented pattern 200 may be stored or represented as an object, a string of text, an XML or JSON document or variable, or any other representation.

Evaluating input data using object oriented pattern 200 may comprise recursively evaluating patterns 202-212 in relation to the input data. In an example, pattern evaluation may be performed by one or more components of computing device 102 (e.g., complex pattern parsing component 108, simple pattern parsing component 110, and/or match validation component 112). When evaluating complex pattern 202 (e.g., using complex pattern parsing component 108), it may be determined that complex pattern 202 is comprised of three sub-patterns: simple pattern 204, complex pattern 206, and simple pattern 208. While the following paragraphs discuss the evaluation of pattern 204-208 in the order above, it will be appreciated that evaluating a pattern and sub-patterns of a pattern may occur in any order (e.g., such that simple pattern 208 is evaluated before simple pattern 204, or such that complex pattern 206 is evaluated before simple pattern 204, etc.).

Evaluating complex pattern 202 may begin with simple pattern 204. Simple pattern 204 may specify an exact, inexact, or range match, among other matches. In an example, simple pattern 204 may be evaluated using simple pattern parsing component 110. At least a subpart of the input data may be compared to simple pattern 204 in order to determine a match. In one example, a partial match may be identified (e.g., such that at least a part of the input data matches at least a part of simple pattern 204). In some examples, it may be determined that simple pattern 204 does not match the input data, causing the evaluation of complex pattern 202 to end. In other examples, evaluation of complex pattern 202 may continue in order to determine whether a partial match (e.g., of complex pattern 206 and/or simple pattern 208) is possible.

The evaluation of complex pattern 202 may continue with the evaluation of complex pattern 206. It may be determined that complex pattern 206 comprises multiple sub-patterns, simple patterns 210 and 212. As a result, simple patterns 210 and 212 may be evaluated in a similar fashion to simple pattern 204, as described above. After simple patterns 210 and 212 are evaluated, complex pattern 206 may evaluate the match results and associated information relating to the evaluation of simple patterns 210 and 212. Complex pattern 206 may determine if any one of simple patterns 210 and 212 were matched, if both simple patterns 210 and 212 were matched, or if simple patterns 210 and 212 are separated by specific data within the input data, among other comparisons. As will be appreciated, complex pattern 206 may perform a variety of analyses on the match results and related information in order to determine whether there is a match for complex pattern 206. As above with simple pattern 204, in some examples the overall evaluation of complex pattern 202 may continue or terminate based on the match result of complex pattern 206, simple pattern 210, and/or simple pattern 212.

Simple pattern 208 may also be evaluated as part of the evaluation of complex pattern 202. Simple pattern 208 may be evaluated in a similar fashion to simple pattern 204, as described above. Once simple pattern 204, complex pattern 206, and simple pattern 208 have been evaluated, complex pattern 202 may analyze the match results from each of the sub-patterns to determine a final match result. In some examples, complex pattern 202 may evaluate the match results from each of the sub-patterns as each sub-pattern is evaluated, rather than evaluating the match results for all of the sub-patterns at once. As discussed above with respect to complex pattern 206, the evaluation of complex pattern 202 may comprise determining which sub-patterns were matched, whether all sub-patterns were matched, the context in which the sub-patterns were matched, among other analyses.

In some examples, evaluating one or more of patterns 202-212 may comprise evaluating validation criteria (e.g., using match validation component 112). In other examples, match identification for patterns 202-212 may be performed in view of one or more properties associated with patterns 202-212, such as whether matches are case sensitive or should ignore whitespace, among other refinements.

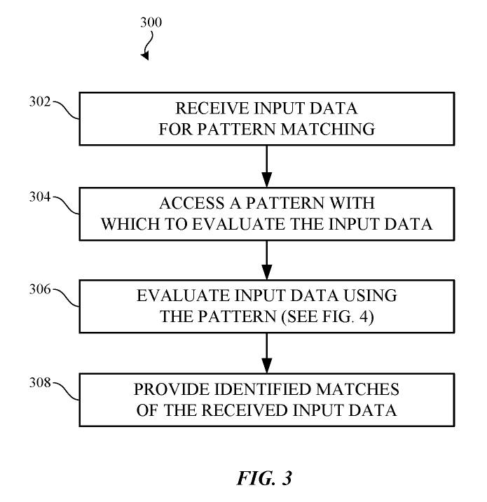

FIG. 3 illustrates an example method 300 for evaluating input data using recursive object oriented pattern matching. Method 300 may be performed by a computing device, such as computing device 102 in FIG. 1. Method 300 begins at operation 302, where input data is received. The input data may be any type of data, including but not limited to, textual data, binary data, a file, a data stream, or any combination thereof.

At operation 304, a pattern for evaluating the input data may be accessed. In an example, the pattern may be stored as an object or a variable, or another data structure. The pattern may be stored in a data store, provided by or as a part of an application, provided or associated with the input data, or accessed using any other techniques. The pattern may comprise a pattern and/or one or more sub-patterns, as discussed herein. As an example, the pattern may be a hierarchy of simple and complex patterns and may have been created by pattern generation component 104 or pattern modification component 106.

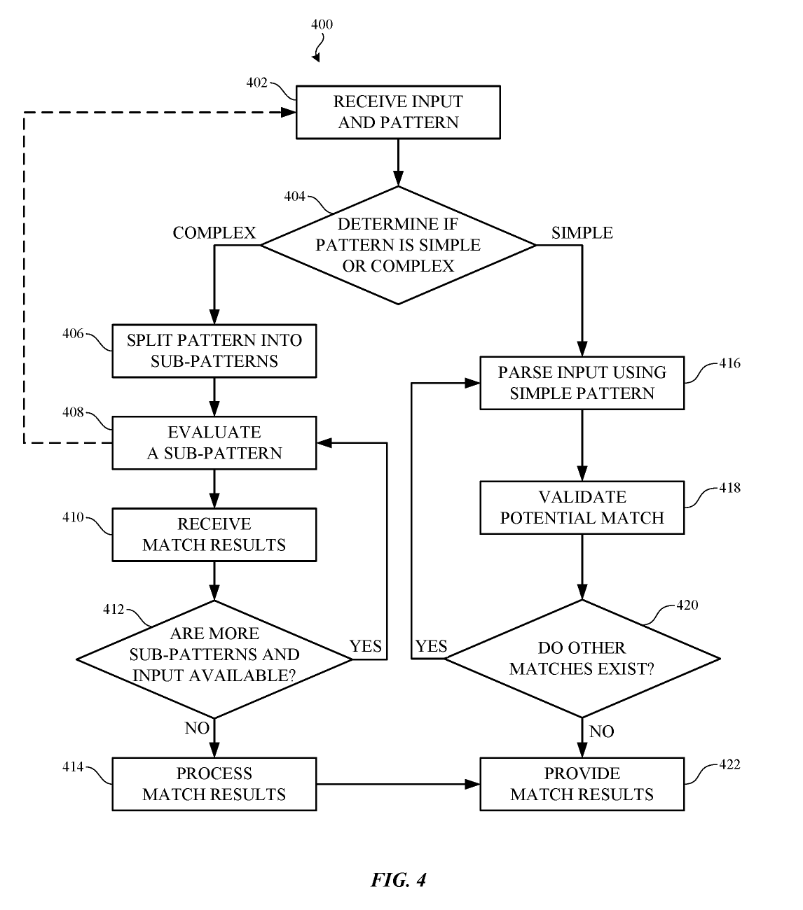

Moving to operation 306, the input data may be evaluated using the pattern. This will be discussed below in greater detail with respect to FIG. 4. Evaluating the input data may be performed using one or more components of computing device 102 in FIG. 1 (e.g., components 104-114). In some examples, the input data may be split into a plurality of subparts and each subpart may be analyzed separately in order to improve performance (e.g., using separate threads or processes, multiple computing devices, etc.). In other examples, different sub-patterns may be evaluated using different components (e.g., complex pattern parsing component 108 and simple pattern parsing component 110). While the instant disclosure provides examples of recursively evaluating object oriented patterns, it will be appreciated that such patterns also be evaluated or parsed using linear or iterative techniques. In an example, a combination of linear and recursive techniques may be used.

At operation 308, matches that were identified by evaluating the pattern at operation 306 may be provided. In some examples, the matches may be provided for further processing (e.g., to match validation component 112 and/or output generation component 114). In other examples, a subpart of the matches may be provided, along with additional information such as confidence score or match percentage information, execution time or resource efficiency metrics, among other data. The provided matches may comprise full matches of the pattern, or they may also or alternatively comprise partial matches. In one example, partial matches may be analyzed (e.g., based on a threshold match percentage, which parts of the pattern were matched, etc.) in order to filter which matches are returned. Flow terminates at operation 308.

FIG. 4 illustrates an example method 400 for evaluating an input using an object oriented pattern. Method 400 may be performed by a computing device, such as computing device 102 in FIG. 1. Method 400 begins at operation 402, where an input and pattern are received. In an example, the input may be any type of data, including but not limited to, textual data, binary data, a file, a data stream, or any combination thereof. The pattern may be accessed from a data store, an application, or from any other location. In an example, the pattern may be an object oriented pattern (e.g., complex pattern 202 of object oriented pattern 200 in FIG. 2). In another example, the input and pattern may be provided as a result of evaluating a sub-pattern of the pattern (e.g., it may be provided by complex pattern parsing component 108 or simple pattern parsing component 110).

At decision operation 404, a determination may be made whether the pattern is simple or complex. The determination may be based on evaluating attributes (e.g., what type of object or data structure the pattern is, how the pattern is formulated, etc.) or properties associated with the pattern (e.g., whether a property is one that is exclusive to one type of pattern, whether a property indicates which type of pattern it is, etc.), among other indications.

If it is determined that the pattern is a complex pattern, flow branches “COMPLEX” to operation 406, where the pattern may be split into one or more sub-patterns. In an example, operations 406-414 may be performed by complex pattern parsing component 108 in FIG. 1. In some examples, splitting the pattern comprises identifying or otherwise enumerating the one or more sub-patterns comprised in the pattern (e.g., the sub-patterns may be complex or simple patterns).

Flow moves to operation 408, where a sub-pattern of the one or more sub-patterns is evaluated. Evaluating the sub-pattern may comprise providing the sub-pattern and at least a subpart of the input to operation 402, and performing operations 402-422 to generate any match results that may exist within the input for the sub-pattern. In some examples, the one or more sub-patterns may be evaluated to determine which sub-pattern should be evaluated first (e.g., based on complexity, order of the sub-patterns, pattern type, etc.).

At operation 410, match results may be received as a result of evaluating the sub-pattern in operation 408. The match results may comprise one or more matches and/or partial matches for the sub-pattern. In some examples, additional information may be received, including, but not limited to, confidence scores or match percentages, or performance metrics. In other examples, the match results may provide an indication that no match was identified.

Moving to decision operation 412, a determination may be made whether there are more sub-patterns and input available for evaluation. If there are more sub-patterns and input available, flow branches “YES” to operation 408, where flow may loop between operations 408, 410, and 412 for each remaining sub-pattern. If, however, there are no remaining sub-patterns, flow branches “NO” to operation 414 where the match results received at operation 410 may be processed.

Processing the match results may comprise evaluating the match results received for each of the sub-patterns in order to generate the match results for the complex pattern. As discussed above, the complex pattern may specify many match types based on the match results returned for each of the sub-patterns, including, but not limited to, that any one of the sub-patterns should be matched, that all of the sub-patterns should be matched, or that each of the sub-patterns are separated by a specific delimiter. In some examples, the matches may be processed based on one or more properties associated with the pattern or sub-patterns. As an example, a parameter may specify what type of delimiter should be used to separate sub-patterns in a match, how many occurrences should be identified, among other properties. In other examples, match processing may comprise validating the matches (e.g., using match validation component 112) using one or more validation criteria as described herein.

At operation 422, the match results may be provided. In some examples, the match results may be provided to another computing device or component (e.g., computing device 102 or output generation component 114). In another example, the match results may be provided as match results for the evaluation of a sub-pattern (e.g., to operation 410). In one example, a portion of the match results may be provided (e.g., they may be filtered based on match percentage, which sub-patterns were matched, etc.). Flow terminates at operation 422.

If, however, it is determined at decision operation 404 that the pattern is a simple pattern, flow branches “SIMPLE” to operation 416, where the input may be parsed using the simple pattern. In an example, the parsing may be performed using simple pattern parsing component 110. The input may be parsed to identify a potential exact match, inexact match, or range match, among other matches. In some examples, one or more properties associated with the simple pattern may be considered when parsing the input, such as whether the simple pattern is case sensitive or whether new line characters should be ignored, among other properties.

Moving to operation 418, a potential match may be validated using one or more validation criteria. The validation may be performed using match validation component 112. Additional processing of the potential match may be performed before the potential match is determined to be a match for the simple pattern, such as comparing the potential match to previously identified matches, validating the contents or syntax of the potential match, or using external information to validate the match, among other processing.

At decision operation 420, a determination may be made whether other matches may exist within the input. As an example, the determination may be based on whether there are remaining subparts of the input that have not yet been evaluated or whether a predetermined amount of time has elapsed since the evaluation began, among other thresholds or criteria. If it is determined that other matches exist, flow branches “YES” to operation 416, where the input may again be parsed using the simple pattern. Flow may loop between operations 416, 418, and 420 as long as matches may exist. If, however, it is determined that no more matches exist, flow branches “NO” to operation 422, where the match results may be provided.

As discussed above, providing the match results may comprise providing the match results to another computing device or component (e.g., computing device 102, complex pattern parsing component 108, or output generation component 114). In another example, the match results may be provided as match results for the evaluation of a sub-pattern (e.g., to operation 410). In one example, a portion of the match results may be provided (e.g., they may be filtered based on match percentage or where in the input data the matches were identified, etc.). Flow terminates at operation 422.

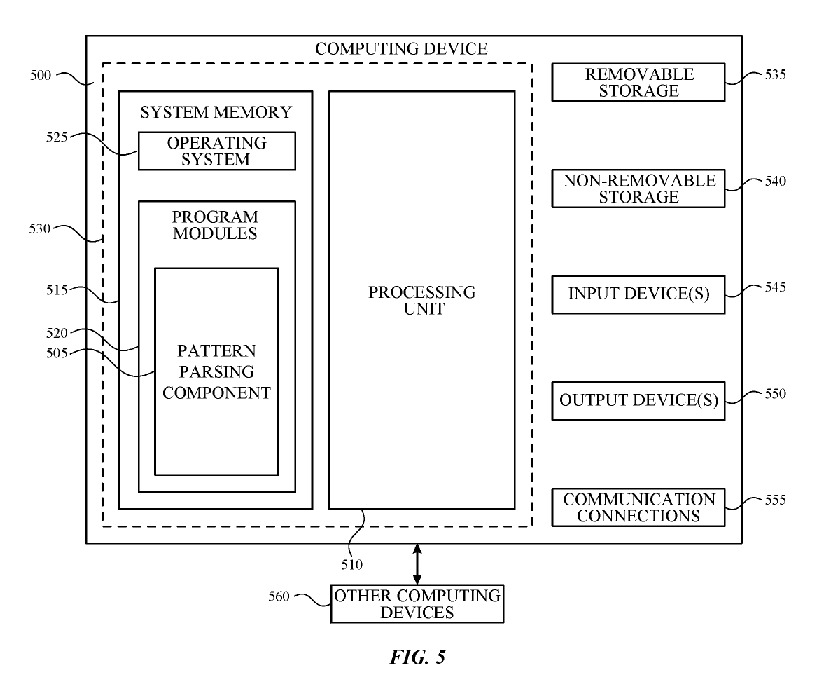

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of electronic device configurations that may be utilized for practicing aspects of the disclosure, as described herein.

FIG. 5 is a block diagram illustrating physical components (e.g., hardware) of an electronic device 500 with which aspects of the disclosure may be practiced. The components of the electronic device 500 described below may have computer executable instructions for generating a mailto link in an electronic communication application such as described above.

In a basic configuration, the electronic device 500 may include at least one processing unit 510 and a system memory 515. Depending on the configuration and type of electronic device, the system memory 515 may comprise, but is not limited to, volatile storage (e.g., random access memory), non-volatile storage (e.g., read-only memory), flash memory, or any combination of such memories. The system memory 515 may include an operating system 525 and one or more program modules 520 suitable for parsing received responses, generating electronic messages, updating attendee lists and so on.

The operating system 525, for example, may be suitable for controlling the operation of the electronic device 500. Furthermore, embodiments of the disclosure may be practiced in conjunction with a graphics library, other operating systems, or any other application program and is not limited to any particular application or system. This basic configuration is illustrated in FIG. 5 by those components within a dashed line 530.

The electronic device 500 may have additional features or functionality. For example, the electronic device 500 may also include additional data storage devices (removable and/or non-removable) such as, for example, magnetic disks, optical disks, or tape. Such additional storage is illustrated in FIG. 5 by a removable storage device 535 and a non-removable storage device 540.

As stated above, a number of program modules and data files may be stored in the system memory 515. While executing on the processing unit 510, the program modules 520 (e.g., the pattern parsing component 505) may perform processes including, but not limited to, the aspects, as described herein.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of the client to switch protocols may be operated via application-specific logic integrated with other components of the electronic device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The electronic device 500 may also have one or more input device(s) 545 such as a keyboard, a trackpad, a mouse, a pen, a sound or voice input device, a touch, force and/or swipe input device, etc. The output device(s) 550 such as a display, speakers, a printer, etc. may also be included. The aforementioned devices are examples and others may be used. The electronic device 500 may include one or more communication connections 555 allowing communications with other electronic devices 560. Examples of suitable communication connections 555 include, but are not limited to, radio frequency (RF) transmitter, receiver, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules.

The system memory 515, the removable storage device 535, and the non-removable storage device 540 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the electronic device 500. Any such computer storage media may be part of the electronic device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

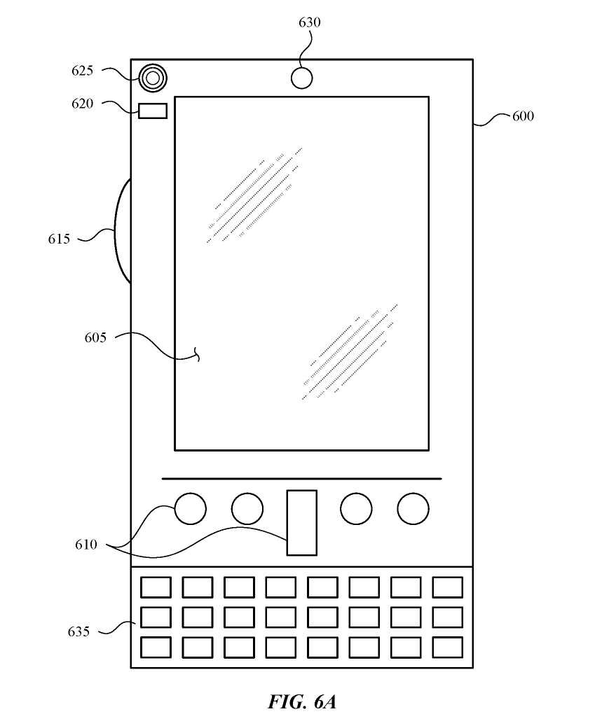

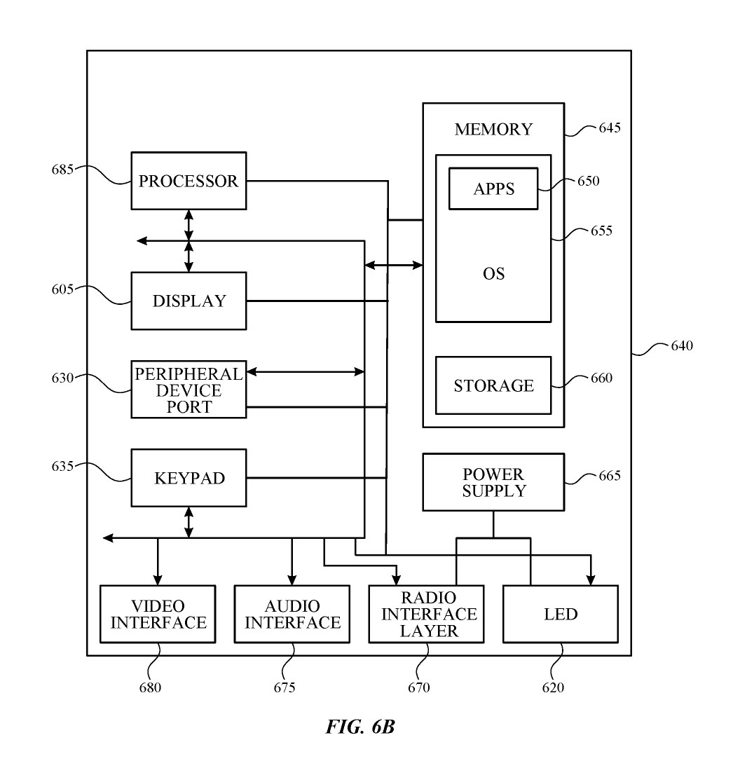

FIGS. 6A and 6B illustrate a mobile electronic device 600, for example, a mobile telephone, a smart phone, wearable computer (such as a smart watch), a tablet computer, a laptop computer, and the like, with which embodiments of the disclosure may be practiced. With reference to FIG. 6A, one aspect of a mobile electronic device 600 for implementing the aspects is illustrated.

In a basic configuration, the mobile electronic device 600 is a handheld computer having both input elements and output elements. The mobile electronic device 600 typically includes a display 605 and one or more input buttons 610 that allow the user to enter information into the mobile electronic device 600. The display 605 of the mobile electronic device 600 may also function as an input device (e.g., a display that accepts touch and/or force input).

If included, an optional side input element 615 allows further user input. The side input element 615 may be a rotary switch, a button, or any other type of manual input element. In alternative aspects, mobile electronic device 600 may incorporate more or less input elements. For example, the display 605 may not be a touch screen in some embodiments. In yet another alternative embodiment, the mobile electronic device 600 is a portable phone system, such as a cellular phone. The mobile electronic device 600 may also include an optional keypad 635. Optional keypad 635 may be a physical keypad or a “soft” keypad generated on the touch screen display.

In various embodiments, the output elements include the display 605 for showing a graphical user interface (GUI), a visual indicator 620 (e.g., a light emitting diode), and/or an audio transducer 625 (e.g., a speaker). In some aspects, the mobile electronic device 600 incorporates a vibration transducer for providing the user with tactile feedback. In yet another aspect, the mobile electronic device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile electronic device 600. That is, the mobile electronic device 600 can incorporate a system (e.g., an architecture) 640 to implement some aspects. In one embodiment, the system 640 is implemented as a “smart phone” capable of running one or more applications (e.g., browser, e-mail, calendaring, contact managers, messaging clients, games, media clients/players, content selection and sharing applications and so on). In some aspects, the system 640 is integrated as an electronic device, such as an integrated personal digital assistant (PDA) and wireless phone.

One or more application programs 650 may be loaded into the memory 645 and run on or in association with the operating system 655. Examples of the application programs include phone dialer programs, e-mail programs, personal information management (PIM) programs, word processing programs, spreadsheet programs, Internet browser programs, messaging programs, and so forth.

The system 640 also includes a non-volatile storage area 660 within the memory 645. The non-volatile storage area 660 may be used to store persistent information that should not be lost if the system 640 is powered down.

The application programs 650 may use and store information in the non-volatile storage area 660, such as email or other messages used by an email application, and the like. A synchronization application (not shown) also resides on the system 640 and is programmed to interact with a corresponding synchronization application resident on a host computer to keep the information stored in the non-volatile storage area 660 synchronized with corresponding information stored at the host computer.

The system 640 has a power supply 665, which may be implemented as one or more batteries. The power supply 665 may further include an external power source, such as an AC adapter or a powered docking cradle that supplements or recharges the batteries.

The system 640 may also include a radio interface layer 670 that performs the function of transmitting and receiving radio frequency communications. The radio interface layer 670 facilitates wireless connectivity between the system 640 and the “outside world,” via a communications carrier or service provider. Transmissions to and from the radio interface layer 670 are conducted under control of the operating system 655. In other words, communications received by the radio interface layer 670 may be disseminated to the application programs 650 via the operating system 655, and vice versa.

The visual indicator 620 may be used to provide visual notifications, and/or an audio interface 675 may be used for producing audible notifications via an audio transducer (e.g., audio transducer 625 illustrated in FIG. 6A). In the illustrated embodiment, the visual indicator 620 is a light emitting diode (LED) and the audio transducer 625 may be a speaker. These devices may be directly coupled to the power supply 665 so that when activated, they remain on for a duration dictated by the notification mechanism even though the processor 685 and other components might shut down for conserving battery power. The LED may be programmed to remain on indefinitely until the user takes action to indicate the powered-on status of the device.

The audio interface 675 is used to provide audible signals to and receive audible signals from the user (e.g., voice input such as described above). For example, in addition to being coupled to the audio transducer 625, the audio interface 675 may also be coupled to a microphone to receive audible input, such as to facilitate a telephone conversation. In accordance with embodiments of the present disclosure, the microphone may also serve as an audio sensor to facilitate control of notifications, as will be described below.

The system 640 may further include a video interface 680 that enables an operation of peripheral device 630 (e.g., on-board camera) to record still images, video stream, and the like. The captured images may be provided to the artificial intelligence entity advertisement system such as described above.

A mobile electronic device 600 implementing the system 640 may have additional features or functionality. For example, the mobile electronic device 600 may also include additional data storage devices (removable and/or non-removable) such as, magnetic disks, optical disks, or tape. Such additional storage is illustrated in FIG. 6B by the non-volatile storage area 660.

Data/information generated or captured by the mobile electronic device 600 and stored via the system 640 may be stored locally on the mobile electronic device 600, as described above, or the data may be stored on any number of storage media that may be accessed by the device via the radio interface layer 670 or via a wired connection between the mobile electronic device 600 and a separate electronic device associated with the mobile electronic device 600, for example, a server computer in a distributed computing network, such as the Internet. As should be appreciated such data/information may be accessed via the mobile electronic device 600 via the radio interface layer 670 or via a distributed computing network. Similarly, such data/information may be readily transferred between electronic devices for storage and use according to well-known data/information transfer and storage means, including electronic mail and collaborative data/information sharing systems.

As should be appreciated, FIGS. 6A and 6B are described for purposes of illustrating the present methods and systems and is not intended to limit the disclosure to a particular sequence of steps or a particular combination of hardware or software components.

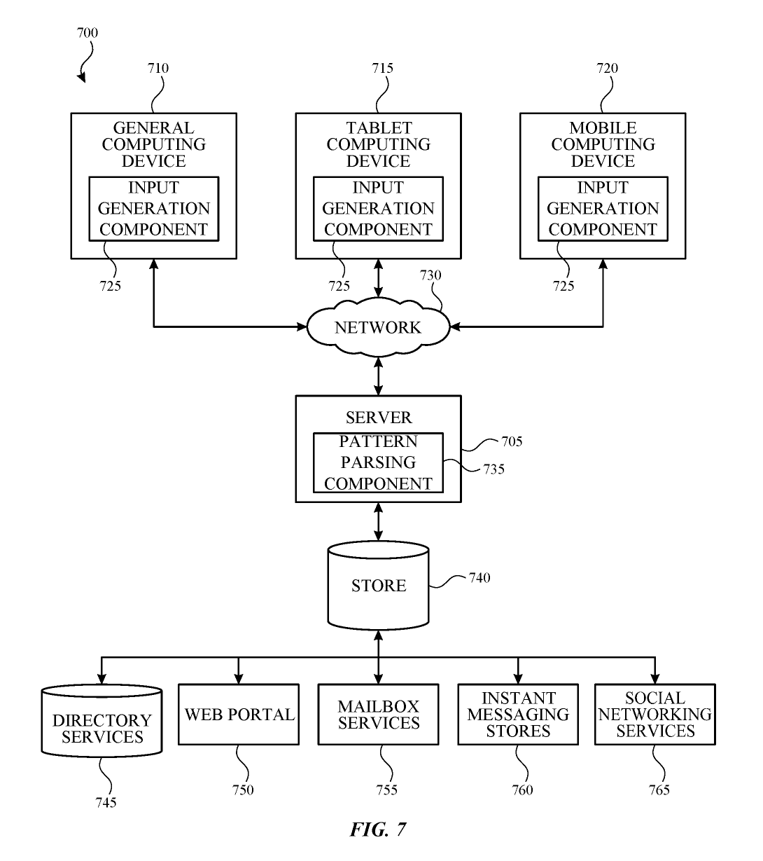

FIG. 7 illustrates one aspect of the architecture of a system 700 in which aspects of the disclosure may be practiced. The system may include a general electronic device 710 (e.g., personal computer), tablet electronic device 715, or mobile electronic device 720, as described above. Each of these devices may include a input generation component 725 and/or a pattern generation component as described herein. The input generation component 725 may be configured to generate or gather input data for object oriented pattern matching as described herein. One or more pattern objects may be used by pattern parsing component 735 to parse or evaluate input data received over the network 730 from input generation component 725.

In some aspects, the pattern parsing component 735 may receive various types of information or content that is stored by the store 740 or transmitted from a directory service 745, a web portal 750, mailbox services 755, instant messaging stores 760, or social networking services 765.

By way of example, the aspects described above may be embodied in a general electronic device 710 (e.g., personal computer), a tablet electronic device 715 and/or a mobile electronic device 720 (e.g., a smart phone). Any of these embodiments of the electronic devices may obtain content from or provide data to the store 740.

As should be appreciated, FIG. 7 is described for purposes of illustrating the present methods and systems and is not intended to limit the disclosure to a particular sequence of steps or a particular combination of hardware or software components.

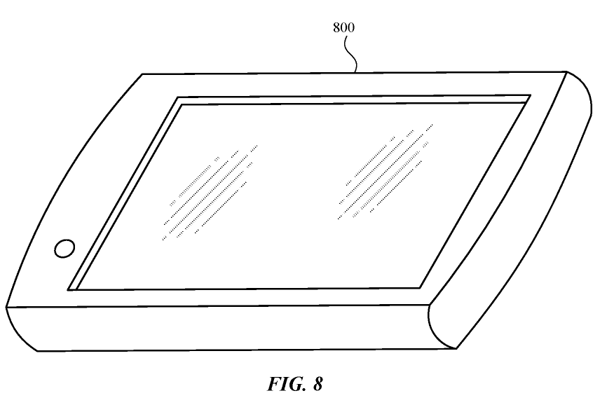

FIG. 8 illustrates an example tablet electronic device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board electronic device displays or via remote display units associated with one or more electronic devices.

For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated electronic device is equipped with detection (e.g., camera) functionality for capturing and interpreting user gestures for controlling the functionality of the electronic device, and the like.

As should be appreciated, FIG. 8 is described for purposes of illustrating the present methods and systems and is not intended to limit the disclosure to a particular sequence of steps or a particular combination of hardware or software components.

As will be understood from the foregoing disclosure, one aspect of the technology relates to a system comprising: at least one processor; and a memory storing instructions which, when executed by the at least one processor, performs a method for parsing input data using recursive object oriented pattern matching. The method comprises: accessing an object oriented pattern, wherein the object oriented pattern is one of a simple pattern and a complex pattern; when the object oriented pattern is a simple pattern, parsing the input data using the object oriented pattern to identify one or more matches of the input data; when the object oriented pattern is a complex pattern comprising logic and one or more sub-patterns, parsing the input data using each of the one or more sub-patterns and the logic to identify one or more matches of the input data; and providing the one or more matches of the input data. In an example, at least one of the one the object oriented pattern and the one or more sub-patterns is associated with verification criteria, and wherein parsing the input data comprises validating at least one of the one or more matches using the verification criteria. In another example, providing the one or more matches comprises: selecting a template resource having one or more fields; and generating, using at least one of the one or more matches, a completed template by populating the one or more fields with information of the one or more matches. In a further example, the one or more matches comprise a partial match of the object oriented pattern. In yet another example, at least one of the object oriented pattern and the one or more sub-patterns is associated with a property, wherein the property indicates one of: case insensitivity; capitalization criteria; one or more values indicating the beginning of a match; one or more values indicating the ending of a match; whether to identify partial matches; match frequency information; match length information; a pattern name; a pattern type; one or more delimiter values; one or more values to allow; and one or more values to exclude. In a further still example, a simple pattern is one of: an exact match; an inexact match; and a match of a set of values. In an example, a complex pattern is one of: a match of multiple occurrences of a sub-pattern match; a match of at least one of one or more sub-patterns; a match of all of one or more sub-patterns; and a match of a plurality of sub-patterns separated by a delimiter.

In another aspect, the technology relates to a computer-implemented method for performing recursive object oriented pattern matching. The method comprises: receiving input data; accessing an object oriented pattern associated with verification criteria, wherein the object oriented pattern is one of a simple pattern and a complex pattern; when the object oriented pattern is a simple pattern, evaluating at least a part of the input data using the object oriented pattern to identify one or more matches of the input data; when the object oriented pattern is a complex pattern comprising criteria and one or more sub-patterns, evaluating at least a part of the input data using each of the one or more sub-patterns and the criteria to identify one or more matches of the input data; validating at least one of the one or more matches using the verification criteria; and providing the one or more matches of the input data. In an example, providing the one or more matches comprises: selecting a template resource having one or more fields; and generating, using at least one of the one or more matches, a completed template by populating the one or more fields with information of the one or more matches. In another example, the one or more matches comprise a partial match of the object oriented pattern. In a further example, least one of the object oriented pattern and the one or more matches is associated with a property, wherein the property indicates one of: case insensitivity; capitalization criteria; one or more values indicating the beginning of a match; one or more values indicating the ending of a match; whether to identify partial matches; match frequency information; match length information; a pattern name; a pattern type; one or more delimiter values; one or more values to allow; and one or more values to exclude. In yet another example, a simple pattern is one of: an exact match; an inexact match; and a match of a set of values. In a further still example, a complex pattern is one of: a match of multiple occurrences of a sub-pattern match; a match of at least one of one or more sub-patterns; a match of all of one or more sub-patterns; and a match of a plurality of sub-patterns separated by a delimiter.

In another aspect, the technology relates to another computer-implemented method for parsing input data using recursive object oriented pattern matching. The method comprises: accessing an object oriented pattern, wherein the object oriented pattern is one of a simple pattern and a complex pattern; when the object oriented pattern is a simple pattern, parsing the input data using the object oriented pattern to identify one or more matches of the input data; when the object oriented pattern is a complex pattern comprising logic and one or more sub-patterns, parsing the input data using each of the one or more sub-patterns and the logic to identify one or more matches of the input data; and providing the one or more matches of the input data. In an example, at least one of the object oriented pattern and the one or more sub-patterns is associated with verification criteria, and wherein parsing the input data comprises validating at least one of the one or more matches using the verification criteria. In another example, providing the one or more matches comprises: selecting a template resource having one or more fields; and generating, using at least one of the one or more matches, a completed template by populating the one or more fields with information of the one or more matches. In a further example, the one or more matches comprise a partial match of the object oriented pattern. In yet another example, at least one of the object oriented pattern and the one or more sub-patterns is associated with a property, wherein the property indicates one of: case insensitivity; capitalization criteria; one or more values indicating the beginning of a match; one or more values indicating the ending of a match; whether to identify partial matches; match frequency information; match length information; a pattern name; a pattern type; one or more delimiter values; one or more values to allow; and one or more values to exclude. In a further still example, a simple pattern is one of: an exact match; an inexact match; and a match of a set of values. In another example, a complex pattern is one of: a match of multiple occurrences of a sub-pattern match; a match of at least one of one or more sub-patterns; a match of all of one or more sub-patterns; and a match of a plurality of sub-patterns separated by a delimiter.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
a memory storing instructions which, when executed by the at least one processor, performs a method for parsing input data using recursive object oriented pattern matching, comprising:
accessing an object oriented pattern, wherein the object oriented pattern is one of a simple pattern and a complex pattern;
when the object oriented pattern is a simple pattern, parsing the input data using the object oriented pattern to identify one or more matches of the input data;
when the object oriented pattern is a complex pattern comprising logic and one or more sub-patterns, parsing the input data using each of the one or more sub-patterns and the logic to identify one or more matches of the input data; and
providing the one or more matches of the input data.

2. The system of claim 1, wherein at least one of the one the object oriented pattern and the one or more sub-patterns is associated with verification criteria, and wherein parsing the input data comprises validating at least one of the one or more matches using the verification criteria.

3. The system of claim 1, wherein providing the one or more matches comprises:
selecting a template resource having one or more fields; and
generating, using at least one of the one or more matches, a completed template by populating the one or more fields with information of the one or more matches.

4. The system of claim 1, wherein the one or more matches comprise a partial match of the object oriented pattern.

5. The system of claim 1, wherein at least one of the object oriented pattern and the one or more sub-patterns is associated with a property, wherein the property indicates one of:
case insensitivity;
capitalization criteria;
one or more values indicating the beginning of a match;
one or more values indicating the ending of a match;
whether to identify partial matches;
match frequency information;
match length information;
a pattern name;
a pattern type;
one or more delimiter values;
one or more values to allow; and
one or more values to exclude.

6. The system of claim 1, wherein a simple pattern is one of:
an exact match;
an inexact match; and
a match of a set of values.

7. The system of claim 1, wherein a complex pattern is one of:
a match of multiple occurrences of a sub-pattern match;
a match of at least one of one or more sub-patterns;
a match of all of one or more sub-patterns; and
a match of a plurality of sub-patterns separated by a delimiter.

8. A computer-implemented method for performing recursive object oriented pattern matching, comprising:
receiving input data;
accessing an object oriented pattern associated with verification criteria, wherein the object oriented pattern is one of a simple pattern and a complex pattern;
when the object oriented pattern is a simple pattern, evaluating at least a part of the input data using the object oriented pattern to identify one or more matches of the input data;
when the object oriented pattern is a complex pattern comprising criteria and one or more sub-patterns, evaluating at least a part of the input data using each of the one or more sub-patterns and the criteria to identify one or more matches of the input data;
validating at least one of the one or more matches using the verification criteria; and
providing the one or more matches of the input data.

9. The computer-implemented method of claim 8, wherein providing the one or more matches comprises:
selecting a template resource having one or more fields; and
generating, using at least one of the one or more matches, a completed template by populating the one or more fields with information of the one or more matches.

10. The computer-implemented method of claim 8, wherein the one or more matches comprise a partial match of the object oriented pattern.

11. The computer-implemented method of claim 8, wherein at least one of the object oriented pattern and the one or more matches is associated with a property, wherein the property indicates one of:
case insensitivity;
capitalization criteria;
one or more values indicating the beginning of a match;
one or more values indicating the ending of a match;
whether to identify partial matches;
match frequency information;
match length information;
a pattern name;
a pattern type;
one or more delimiter values;
one or more values to allow; and
one or more values to exclude.

12. The computer-implemented method of claim 8, wherein a simple pattern is one of:
an exact match;
an inexact match; and
a match of a set of values.

13. The computer-implemented method of claim 8, wherein a complex pattern is one of:
a match of multiple occurrences of a sub-pattern match;
a match of at least one of one or more sub-patterns;
a match of all of one or more sub-patterns; and
a match of a plurality of sub-patterns separated by a delimiter.

14. A computer-implemented method for parsing input data using recursive object oriented pattern matching, comprising:
accessing an object oriented pattern, wherein the object oriented pattern is one of a simple pattern and a complex pattern;
when the object oriented pattern is a simple pattern, parsing the input data using the object oriented pattern to identify one or more matches of the input data;
when the object oriented pattern is a complex pattern comprising logic and one or more sub-patterns, parsing the input data using each of the one or more sub-patterns and the logic to identify one or more matches of the input data; and
providing the one or more matches of the input data.

15. The computer-implemented method of claim 14, wherein at least one of the object oriented pattern and the one or more sub-patterns is associated with verification criteria, and wherein parsing the input data comprises validating at least one of the one or more matches using the verification criteria.

16. The computer-implemented method of claim 14, wherein providing the one or more matches comprises:
selecting a template resource having one or more fields; and
generating, using at least one of the one or more matches, a completed template by populating the one or more fields with information of the one or more matches.

17. The computer-implemented method of claim 14, wherein the one or more matches comprise a partial match of the object oriented pattern.

18. The computer-implemented method of claim 14, wherein at least one of the object oriented pattern and the one or more sub-patterns is associated with a property, wherein the property indicates one of:
case insensitivity;
capitalization criteria;
one or more values indicating the beginning of a match;
one or more values indicating the ending of a match;
whether to identify partial matches;
match frequency information;
match length information;
a pattern name;
a pattern type;
one or more delimiter values;
one or more values to allow; and
one or more values to exclude.

19. The computer-implemented method of claim 14, wherein a simple pattern is one of:
an exact match;
an inexact match; and
a match of a set of values.

20. The computer-implemented method of claim 14, wherein a complex pattern is one of:
a match of multiple occurrences of a sub-pattern match;
a match of at least one of one or more sub-patterns;
a match of all of one or more sub-patterns; and
a match of a plurality of sub-patterns separated by a delimiter.
